(19) United States
(12) Patent Application Publication
(10) Pub. No.: US 2026/0330265 A1
(43) Pub. Date: Oct. 22, 2026

(54) METHOD FOR TRAINING QUESTION ANSWERING LARGE LANGUAGE MODEL, METHOD FOR ANSWERING QUESTIONS, AND ELECTRONIC DEVICE

(71) Applicant: BEIJING BAIDU NETCOM SCIENCE TECHNOLOGY CO., LTD., Beijing (CN)

(72) Inventors: Mingzhu Cai, Beijing (CN); Shaoning Sun, Beijing (CN); Huang He, Beijing (CN); Bingjin Chen, Beijing (CN); Siqi Bao, Beijing (CN); Hua Wu, Beijing (CN); Haifeng Wang, Beijing (CN)

(73) Assignee: BEIJING BAIDU NETCOM SCIENCE TECHNOLOGY CO., LTD., Beijing (CN)

(21) Appl. No.: 19/713,214

(22) Filed: Jun. 18, 2026

(30) Foreign Application Priority Data
Mar. 23, 2026 (CN) 202610360093.1

(51) Int. Cl. G06N 5/04

(52) U.S. Cl. CPC G06N 5/04

(57) ABSTRACT

A method for training a question answering large language model is performed by an electronic device, including: obtaining a candidate question answering large language model to be trained, and a corresponding sample question; obtaining output answers to the sample question by invoking a model capability of the candidate question answering large language model, and obtaining target answer results to the sample question by sampling the output answers; obtaining a target distribution description data of the target answer results; and obtaining an update gradient of the candidate question answering large language model based on the target distribution description data, and training the candidate question answering large language model based on the update gradient to obtain a target question answering large language model.

### CROSS-REFERENCE TO RELATED APPLICATION

This application is based on and claims priority to Chinese Patent Application Serial No. 202610360093.1, filed on Mar. 23, 2026, the entire contents of which are incorporated herein by reference.

### TECHNICAL FIELD

The disclosure relates to the field of large language model technology, and in particular to the field of artificial intelligence such as natural language processing.

### BACKGROUND

With the development of technology, more and more people rely on asking questions to artificial intelligence and using artificial intelligence to answer to questions proposed by the user, wherein the question answering model can be trained based on training samples constructed from external data, which is highly dependent on external data and incurs high training costs.

### SUMMARY

According to a first aspect of the disclosure, a method for training a question answering large language model is provided. The method includes: obtaining a candidate question answering large language model to be trained, and a corresponding sample question; obtaining output answers to the sample question by invoking a model capability of the candidate question answering large language model, and obtaining target answer results to the sample question by sampling the output answers; obtaining a target distribution description data of the target answer results; and obtaining an update gradient of the candidate question answering large language model based on the target distribution description data, and training the candidate question answering large language model based on the update gradient to obtain a target question answering large language model.

According to a second aspect of the disclosure, a method for answering questions is provided. The method includes: obtaining a question object to be answered; and generating a target answer based on the question object by invoking a model capability of a target question answering large language model, wherein the target question answering large language model is obtained based on the method for training a question answering large language model provided in the first aspect.

According to a third aspect of the disclosure, an electronic device is provided. The electronic device includes: at least one processor; and a memory communicatively coupled to the at least one processor and storing instructions executable by the at least one processor; in which when the instructions are executed by the at least one processor, the at least one processor can perform the method for training a question answering large language model provided in the first aspect and/or the method for answering questions provided in the second aspect.

According to a fourth aspect of the disclosure, a non-transitory computer readable storage medium is provided, which stores computer instructions. The computer instructions are configured to enable a computer to perform the method for training a question answering large language model provided in the first aspect.

According to a fifth aspect of the disclosure, a computer program product is provided. The computer program product includes a computer program which when executed by a processor, the method for training a question answering large language model provided in the first aspect and/or the method for answering questions provided in the second aspect is implemented.

It should be understood that what is described in this section is not intended to identify key or important features of embodiments of the disclosure, nor is it intended to limit the scope of the disclosure. Other features of the disclosure will be readily understood by the following specification.

### BRIEF DESCRIPTION OF THE DRAWINGS

The accompanying figures are used for a better understanding of the disclosure and do not constitute a limitation on the disclosure.

FIG. 1 is a schematic flowchart of a method for training a question answering large language model according to an embodiment of the disclosure.

FIG. 2 is a schematic flowchart of a method for training a question answering large language model according to another embodiment of the disclosure.

FIG. 3 is a schematic flowchart of a method for training a question answering large language model according to another embodiment of the disclosure.

FIG. 4 is a schematic flowchart of a method for answering questions according to an embodiment of the present disclosure.

FIG. 5 is a block diagram of an apparatus for training a question answering large language model according to an embodiment of the present disclosure.

FIG. 6 is a block diagram of an apparatus for answering questions according to an embodiment of the present disclosure.

FIG. 7 is a block diagram of an electronic device according to an embodiment of the disclosure.

### DETAILED DESCRIPTION

Exemplary embodiments of the disclosure are described hereinafter in conjunction with the accompanying drawings, which include various details of the embodiments of the disclosure in order to aid in understanding, and should be considered exemplary only. Accordingly, one of ordinary skill in the art should recognize that various changes and modifications can be made to the embodiments described herein without departing from the scope and spirit of the disclosure. Similarly, descriptions of well-known features and structures are omitted from the following description for the sake of clarity and brevity.

Large Language Model (LLM) refers to a deep learning model trained on a large amount of textual data, which enables the model to generate natural language text or understand the meaning of language text. These models can provide in-depth knowledge and language production on various topics by training on large datasets. The core idea is to learn the patterns and structures of natural language through large-scale unsupervised training, to some extent simulating human language cognition and generation processes.

Natural Language Processing (NLP) is an important direction in the fields of computer science and artificial intelligence. It studies various theories and methods that enable effective communication between humans and computers using natural language. Natural language processing is a science that integrates linguistics, computer science, and mathematics, which is mainly applied in machine translation, public opinion monitoring, automatic summarization, viewpoint extraction, text classification, question answering, text semantic comparison, speech recognition, Chinese OCR, and other fields.

Artificial Intelligence (AI) is an important driving force for the new round of technological revolution and industrial transformation. It is a new technological science that studies and develops theories, methods, technologies, and application systems for simulating, extending, and expanding human intelligence. Artificial intelligence is an important component of the field of intelligence, attempting to understand the essence of intelligence and produce a new type of intelligent machine that can respond in a way similar to human intelligence. Artificial intelligence is a very broad science, including robotics, language recognition, image recognition, natural language processing, expert systems, machine learning, computer vision, and so on.

It should be noted that the acquisition, storage, use, and processing of data in the technical solution of the disclosure comply with relevant national laws and regulations, and do not violate public order and good customs.

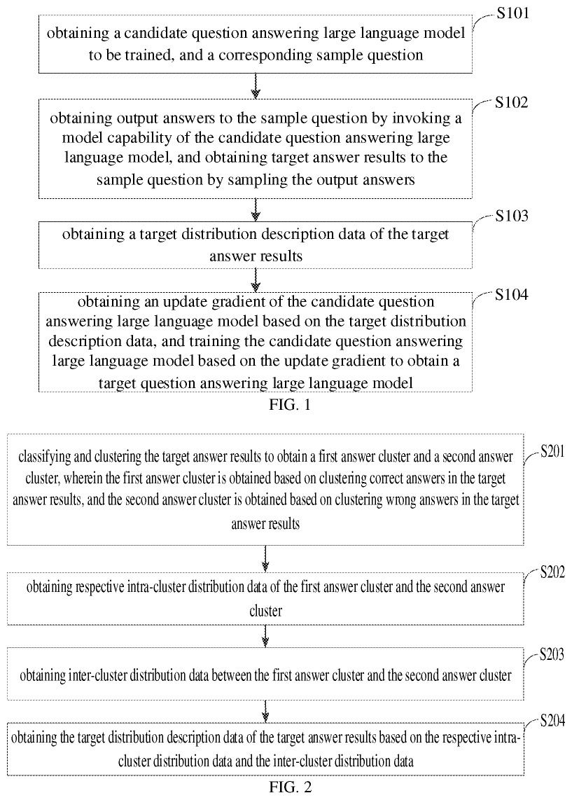

FIG. 1 is a schematic flowchart of a method for training a question answering large language model according to an embodiment of the present disclosure. As shown in FIG. 1, the method includes the following content.

At S101, a candidate question answering large language model to be trained and a corresponding sample question are obtained.

In embodiments of the disclosure, people can use artificial intelligence to parse the questions raised and generate corresponding answer results to return to the corresponding client, thereby achieving the solution to the problem.

In this scenario, problem solving can be achieved by relying on a large language model of artificial intelligence. The large language model used for problem solving can be identified as the question answering large language model. Before the question answering large language model is used for problem solving, relevant model training can be conducted on the question answering large language model to improve its accuracy.

In embodiments of the disclosure, the question answering large language model that needs to be trained can be determined as the candidate question answering large language model to be trained, where the candidate question answering large language model may be a large language model that uses text as the answer information carrier, or a large language model that uses images as the answer information carrier, or a large language model that uses text and images as the answer information carrier, without specific limitation here.

In embodiments of the disclosure, the candidate question answering large language model requires corresponding training samples for model training, and the questions carried in the training samples may be determined as the sample questions for training the candidate question answering large language model.

The sample question that meets the training requirements of the candidate question answering large language model may be selected from open source datasets, or a sample question construction method in related technologies may also be used to construct the sample question for the candidate question answering large language model, without specific limitations here.

At S102, output answers to the sample question are obtained by invoking a model capability of the candidate question answering large language model, and target answer results to the sample question are obtained by sampling the output answers.

In embodiments of the disclosure, the sample question can be input into the candidate question answering large language model, and the model capability of the candidate question answering large language model can be used to analyze and extract features from the sample question, thereby generating a response that can answer the sample question and outputting it as the output answer to the sample question.

In embodiments of the disclosure, the candidate question answering large language model may generate multiple output answers based on the sample question. In this scenario, the output answers of the candidate question answering large language model can be sampled based on a preset sampling strategy to extract at least some answers that meet the preset conditions from the output answers as the output answers required for model training of the candidate question answering large language model. Based on the output answers obtained from this sampling, the answer results of the sample question can be obtained as the target answer results.

As a possible implementation, the model capability of the candidate question answering large language model can be invoked to generate at least one round of answers to the sample problem, and the output answers for each round can be sampled until a part of output answers that meet the preset conditions are obtained. Then, this part of output answers can be determined as the target answer results for the sample question.

It should be noted that each output answer included in the target answer results is an independent answer, which means that each output answer can independently answer the sample question.

At S103, target distribution description data of the target answer results is obtained.

In embodiments of the disclosure, the target answer results include multiple output answers, wherein the answer content of each output answer may differ. In this scenario, there may be a certain degree of difference in the relevant data of each output answer.

In this scenario, based on the distribution acquisition methods in related technologies, the distribution of relevant data for each output answer included in the target answer results may be obtained, and the data that can describe the distribution may be determined as the target distribution description data for the target answer results.

At S104, an update gradient of the candidate question answering large language model is obtained based on the target distribution description data, and the candidate question answering large language model is trained based on the update gradient to obtain a target question answering large language model.

In embodiments of the disclosure, an algorithm for obtaining the update gradient of the model in related technologies may be used to process the target distribution description data of the target answer results. Based on the result of the algorithm, the update gradient obtained from the target distribution description data can be obtained and used as the update gradient for adjusting and optimizing model parameters of the candidate question answering large language model.

In this scenario, the optimization method of model parameters in related technologies can be used to adjust and optimize the model parameters of the candidate question answering large language model based on the update gradient, and the training of the candidate question answering large language model can be ended until the preset training end condition is met, and the trained candidate question answering large language model can be determined as the target question answering large language model.

That is to say, the same sample question can be input into the candidate question answering large model at least one round to obtain at least one round of output answers from the candidate question answering large language model. The target answer results can be obtained from the output answers of the at least one round, and based on the target distribution description data corresponding to the target answer results, the update gradient of the candidate question answering large language model in the current training round can be obtained, thereby achieving the adjustment and optimization of the model parameters of the candidate question answering large language model in the current training round.

In this scenario, the adjusted and optimized candidate question answering large language model of the current training round may be compared with the preset model training end condition. When it matches the training end condition, the model training of the candidate question answering large language model may be ended, and the adjusted and optimized candidate question answering large language model of the current training round may be determined as the target question answering large language model.

Correspondingly, if the adjusted and optimized candidate question answering large language model of the current training round does not match the preset model training end condition, the next sample question may be obtained and the candidate question answering large language model may be trained in the next round until the training is completed to obtain the target question answering large language model.

The method for training a question answering large language model proposed in this disclosure utilizes the model capability of the candidate question answering large language model to generate output answers to the sample question, samples the output answers to obtain corresponding target answer results, and then obtains the update gradient of the candidate question answering large language model based on the target distribution description data corresponding to the target answer results, in order to train the candidate question answering large language model and obtain the target question answering large language model. In this disclosure, the update gradient required for optimizing the large language model is obtained based on the target answer results obtained through output answer sampling, which reduces the dependence of the model training of the question answering large language model on external data and thus reduces the training cost of the question answering large language model; the target distribution description data of the target answer results is used to optimize the candidate question answering large language model, which improves the model performance of the target question answering large language model, and optimizes the answer accuracy and precision of the target question answering large language model when answering questions; the model optimization is performed through the update gradient corresponding to the target distribution description data, which improves the guidance of the target distribution description data on the model optimization of the candidate question answering large language model, and improves the intuitiveness and quantifiability of the model optimization reference data. This optimizes the training method and training performance of the question answering large language model. In the scenario of question answering based on the target question answering large language model, the efficiency and accuracy of question answering have been improved, and the user experience has been optimized.

In the above embodiments, obtaining the target distribution description data for the target answer results can be further understood in conjunction with FIG. 2. FIG. 2 is a schematic flowchart of a method for training a question answering large language model according to another embodiment of the present disclosure. As shown in FIG. 2, the method includes the following content.

At S201, the target answer results are classified and clustered to obtain a first answer cluster and a second answer cluster, wherein the first answer cluster is obtained based on clustering correct answers in the target answer results, and the second answer cluster is obtained based on clustering wrong answers in the target answer results.

Optionally, the correctness of the target answer results can be verified to classify them into a group of correct answers that have passed the verification and a group of wrong answers that have not passed the verification.

In embodiments of the disclosure, the correctness verification of each output answer included in the target answer results may be performed based on the answer correctness verification algorithm in related technologies, in order to filter out the correct answers that have passed verification and the wrong answers that have not passed verification from the various output answers included in the target answer results.

In this scenario, data group generation algorithms in related technologies can be used to generate the group of correct answers that have passed verification and the group of wrong answers that have not passed verification, to obtain the correct answer group based on respective correct answers and obtain the wrong answer group based on respective wrong answers.

Optionally, a first answer probability of each first answer in the correct answer group is obtained, and a second answer probability of each second answer in the wrong answer group is obtained.

In embodiments of the disclosure, the answers included in the correct answer group can be determined as the first answer, and the answers included in the wrong answer group can be determined as the second answer. In this scenario, any one of the first and second answers can be determined as a third answer, and the process of obtaining the answer probabilities of the first and second answers can be understood through the process of obtaining the answer probability of the third answer.

The probability of the first answer generated by the candidate question answering large language model can be determined as the first answer probability of the first answer, and the probability of the second answer generated by the candidate question answering large language model can be determined as the second answer probability of the second answer.

It should be noted that based on the sequence level probability obtaining algorithm in related technologies, corresponding algorithm processing can be applied to any of the first and second answers, and the sequence level probability obtained by the algorithm processing can be determined as the answer probability of that answer.

Optionally, for any third answer, a token generation probability of each answer token in the third answer is obtained, and based on a probability mean of respective token generation probabilities, the third answer probability of the third answer is obtained, wherein the third answer is one of the first answers and the second answers, and the third answer probability is one of the first answer probability and the second answer probability.

In embodiments of the disclosure, for any third answer from the first and second answers, the tokens included in the third answer can be obtained and determined as answer tokens in the third answer.

In this scenario, based on the algorithm for obtaining the token generation probability in related technologies, the generation probability of each answer token generated by the candidate question answering large language model can be obtained and determined as the token generation probability of each answer token. Based on the mean algorithm in related technologies, the mean of the token generation probabilities of each answer token can be calculated to obtain the probability mean of each answer token.

In this scenario, the probability mean can be determined as the answer probability of the third answer generated by the candidate question answering large language model, that is, the third answer probability of the third answer.

As an example, the third answer probability may be obtained based on the following formula:

$$P ( y \vert q ) = {( {\prod }_{i = 1}^{L} P ( {y}_{i} \vert q , {y}_{0 : i - 1} ) )}^{\frac{1}{L}}$$

where, P(y|q) represents the third answer probability, q represents the sample question, y represents the third answer, L represents a sequence length of the third answer, and i represents an identifier of the third answer.

Optionally, respective first answers are clustered based on the first answer probabilities to obtain a first answer cluster, and respective second answers are clustered based on the second response probabilities to obtain a second answer cluster.

In embodiments of the disclosure, clustering methods in related technologies can be used to cluster respective first answers based on respective first answer probabilities, and the resulting cluster can be determined as the first answer cluster based on respective first answers. Similarly, clustering methods in related technologies can be used to cluster respective second answers based on respective second answer probabilities, and the resulting cluster can be determined as the second answer cluster based on respective second answers.

At S202, respective intra-cluster distribution data of the first answer cluster and the second answer cluster is obtained.

As a possible implementation, data that can describe the distribution of respective answers of the first answer cluster and the second answer cluster may be obtained based on the following method, and this data may be determined as the respective intra-cluster distribution data of the first and second answer clusters.

It should be noted that the third answer cluster is one of the first answer cluster and the second answer cluster, the third answer probability is one of the first answer probability and the second answer probability, and the remaining answer is an answer other than the third answer in the third answer cluster.

That is to say, any one of the first and second answer clusters can be selected as the third answer cluster, and any one of answers in the third answer cluster can be determined as the third answer, and other answers in the third answer cluster except for this third answer can be determined as the remaining answers corresponding to this third answer in the third answer cluster.

In this scenario, for any third answer, based on the third answer probabilities of the third answer and a remaining answer in the third answer cluster to which the third answer belongs, an intra-cluster distance between the third answer and the remaining answer is obtained, so as to obtain an intra-cluster mean distance corresponding to the third answer.

In embodiments of the disclosure, the third answer probability of the third answer and the third answer probability of the remaining answer can be processed based on distance obtaining algorithms in related technologies, so as to obtain the distance between the third answer and the remaining answer based on the result of processing, and determine the distance as the intra-cluster distance between the third answer and the remaining answer.

In embodiments of the disclosure, the intra-cluster distance between the third answer and each remaining answer can be obtained based on the above method. In this scenario, the intra-cluster distance between the third answer and each remaining answer can be processed using the distance mean algorithm in related technologies to obtain the mean of respective intra-cluster distances, which is determined as the intra-cluster mean distance corresponding to the third answer.

Optionally, based on the intra-cluster mean distances of respective third answers, the intra-cluster distribution data of the third answer cluster is obtained.

In embodiments of the disclosure, based on the intra-cluster mean distances of respective third answers included in the third answer cluster, the distribution of respective third answers included in the third answer cluster can be obtained. In this scenario, the data that can describe the distribution of respective third answers in the third answer cluster obtained based on the intra-cluster mean distances of respective third answers can be determined as the intra-cluster distribution data of the third answer cluster.

In this scenario, based on the distribution description data obtaining algorithm in related technologies, the intra-cluster mean distances of respective third answers can be processed by the algorithm. Based on the result of the processing, intra-cluster distribution data that can describe the distribution of answers in the third answer cluster can be obtained.

As another possible implementation, the respective intra-cluster distribution data of the first answer cluster and the second answer cluster may also be obtained based on the following content.

Optionally, a first answer probability mean of first answer probabilities of respective first answers in the first answer cluster is obtained, and the intra-cluster distribution data of the first answer cluster is obtained based on the first answer probability mean, as well as a second answer probability mean of respective second answer probabilities of respective second answers in the second answer cluster is obtained, and the intra-cluster distribution data of the second answer cluster is obtained based on the second answer probability mean.

In embodiments of the disclosure, a probability mean algorithm in related technologies can be used to perform processing of mean obtaining on first answer probabilities of respective first answers in the first answer cluster. Based on the result of the processing, the mean of respective first answer probabilities can be obtained, and determined as the first answer probability mean of respective first answer probabilities.

Furthermore, a processing of mean obtaining is performed on second answer probabilities of respective second answers in the second answer cluster, and based on the result of the processing, the mean of respective second answer probabilities is obtained, and determined as the second answer probability mean of respective second answer probabilities.

In this scenario, the algorithm for obtaining description data of distribution in related technologies can be used to process the first answer probability mean and the second answer probability mean respectively. Based on the results of the processing, intra-cluster distribution data that can describe the discrete distribution of respective first answers in the first answer cluster and intra-cluster distribution data that can describe the discrete distribution of respective second answers in the second answer cluster can be obtained.

At S203, inter-cluster distribution data between the first answer cluster and the second answer cluster is obtained.

As a possible implementation, in the scenario of obtaining the respective intra-cluster distribution data of the first answer cluster and the second answer cluster based on the intra-cluster mean distance and inter-cluster mean distance, obtaining the inter-cluster distribution data between the first answer cluster and the second answer cluster can be understood in conjunction with the following content.

Optionally, for any first answer, based on the first answer probability of the first answer and the second answer probabilities of respective second answers in the second answer cluster, first inter-cluster distances between the first answer and respective second answers are obtained, to obtain a first inter-cluster mean distance corresponding to the first answer.

In embodiments of the disclosure, based on distance obtaining algorithms in related technologies, the first answer probability of the first answer and the second answer probability of the second answer can be processed by algorithms, and then the distance between the first answer and the second answer can be obtained based on the result of the processing. This distance can determine the first inter-cluster distance between the first answer and the second answer.

In this scenario, the mean algorithm in related technologies can be used to process the first inter-cluster distances between the first answer and respective second answers. Based on the result of the processing, the mean of respective first inter-cluster distances can be obtained, and this mean can be determined as the first inter-cluster mean distance corresponding to the first answer.

Optionally, for any second answer, based on the second answer probability of the second answer and the first answer probabilities of respective first answers in the first answer cluster, the second inter-cluster distances between the second answer and respective first answers are obtained, to obtain the second inter-cluster mean distance corresponding to the second answer.

In embodiments of the disclosure, obtaining the second inter-cluster mean distance corresponding to the second answer can be understood by referring to the process of obtaining the the first inter-cluster mean distance corresponding to the first answer mentioned above, and will not be repeated here.

Optionally, based on the first inter-cluster mean distances of respective first answers and the second inter-cluster mean distances of respective second answers, the inter-cluster distribution data can be obtained.

In embodiments of the disclosure, algorithm processing can be performed on the first inter-cluster mean distances of respective first answers and the second inter-cluster mean distances of respective second answers using an algorithm for obtaining description data of distribution in related technologies. Based on the result of the algorithm processing, data that can describe the degree of inter-cluster dispersion between the first and second answer clusters can be obtained, and this data can be determined as the inter-cluster distribution data between the first and second answer clusters.

As another possible implementation, in the scenario where the respective intra-cluster distribution data of the first answer cluster and the second answer cluster is obtained based on the first answer probability mean and the second answer probability mean, the inter-cluster distribution data between the first answer cluster and the second answer cluster can be obtained using the following method.

Optionally, a first cluster standard deviation corresponding to the first answer cluster is obtained based on respective first answer probabilities.

In embodiments of the disclosure, based on the standard deviation algorithm in related technologies, respective first answer probabilities in the first answer cluster can be processed by the algorithm, and the corresponding standard deviation can be obtained based on the result of the processing. This standard deviation can be determined as the first cluster standard deviation corresponding to the first answer cluster.

Optionally, a second cluster standard deviation corresponding to the second answer cluster is obtained based on respective second answer probabilities.

In embodiments of the disclosure, the process of obtaining the second cluster standard deviation of the second answer cluster can be understood in conjunction with the process of obtaining the first cluster standard deviation of the first answer cluster proposed above, and will not be repeated here.

Optionally, based on the first cluster standard deviation and the second cluster standard deviation, the inter-cluster distribution data between the first and second answer clusters is obtained.

In embodiments of the disclosure, the first cluster standard deviation and the second cluster standard deviation can be processed using algorithms for obtaining description data of the distribution situation in related technologies. Based on the result of the processing, data that can describe the degree of dispersion between the first and second answer clusters can be obtained, and this data can be determined as the inter-cluster distribution data between the first and second answer clusters.

At S204, the target distribution description data of the target answer results is obtained based on the respective intra-cluster distribution data and the inter-cluster distribution data.

As a possible implementation, based on the respective intra-cluster distribution data and the inter-cluster distribution data, an answer evaluation parameter of each of the first answers and the second answers is obtained, and the target distribution description data is obtained based on a parameter mean value of answer evaluation parameters of respective first answers and second answers.

In embodiments of the disclosure, evaluation methods in related technologies can be used to evaluate respective first answers and respective second answers included in the target answer results based on the respective intra-cluster distribution data of the first answer cluster and the second answer cluster, as well as the inter-cluster distribution data between the first answer cluster and the second answer cluster. The parameter results obtained from the evaluation are determined as the evaluation parameters for respective first answers and respective second answers.

The answer evaluation parameters can be obtained based on the following process.

Optionally, for any third answer, a distance difference between the first inter-cluster mean distance corresponding to the third answer and the intra-cluster mean distance corresponding to the third answer is obtained based on the respective intra-cluster distribution data and the inter-cluster distribution data, and the answer evaluation parameter of the third answer is obtained based on the distance difference, the first inter-cluster mean distance and the intra-cluster mean distance.

In embodiments of the disclosure, for any third answer among respective first answers and second answers, the intra-cluster mean distance of the third answer in its own cluster and the first inter-cluster mean distances between the third answer and respective answers in the other luster can be obtained from the respective intra-cluster distribution data of the first and second answer clusters, as well as the inter-cluster distribution data of the two clusters.

Based on the difference obtaining algorithm in related technologies, the first inter-cluster mean distance and intra-cluster mean distance can be processed by the algorithm to obtain the difference between the two as the distance difference. Then, based on the preset algorithm, the distance difference, the first inter-cluster mean distance, and the intra-cluster mean distance can be processed to obtain the answer evaluation parameter corresponding to the third answer.

As an example, the answer evaluation parameter may be obtained based on the following formula:

$${s}_{i} = \frac{( {b}_{i} - {a}_{i} )}{max ( {a}_{i} , {b}_{i} )}$$

where, sᵢ represents the answer evaluation parameter, (bᵢ−aᵢ) represents the distance difference, bᵢ represents the first inter-cluster mean distance, aᵢ represents the intra-cluster mean distance, and i represents the identifier of each first answer and each second answer.

In embodiments of the disclosure, after obtaining the answer evaluation parameters of respective first answers and respective second answers, the answer evaluation parameters can be processed using the mean algorithm in related technologies. Based on the result of the processing, the parameter mean of respective answer evaluation parameters can be obtained, and then the target distribution description data of the target answer results can be obtained based on the parameter mean.

As an example, the target distribution description data may be calculated based on the following formula:

D=mean(s₁,s₂,s₃, . . . ,sᵢ)
where, D represents the target distribution description data obtained based on the parameter mean, mean( ) represents the mean algorithm, s₁, s₂, s₃, . . . , sᵢ represents respective answer evaluation parameters of respective first answers and respective second answers.

As another possible implementation, a mean difference is obtained by subtracting the second answer probability mean from the first answer probability mean based on the respective intra-cluster distribution data, a sum of respective squared values of the first cluster standard deviation and the second cluster standard deviation is obtained based on the inter-cluster distribution data, and the target distribution description data of the target answer results is obtained based on the mean difference and the sum.

In embodiments of the disclosure, based on the respective intra-cluster distribution data of the first answer cluster and the second answer cluster, the first answer probability mean corresponding to the first answer cluster and the second answer probability mean of the second answer cluster can be obtained. In this scenario, the difference algorithm can be used to process the two to obtain the mean difference between the first answer probability mean and the second answer probability mean.

Based on the standard deviation algorithm in related technologies, respective first answer probabilities in the first answer cluster are processed by the algorithm, and the obtained standard deviation is determined as the first cluster standard deviation of the first answer cluster, and the standard deviation of the second answer cluster is obtained based on the same method as the second cluster standard deviation of the second answer cluster.

In this scenario, the target distribution description data corresponding to the target answer results can be obtained based on the following formula:

$$D = \frac{{( {μ}_{+} - {μ}_{-} )}^{2}}{( {σ}_{+}^{2} + {σ}_{-}^{2} )}$$

where, D represents the target distribution description data corresponding to the target answer results, μ₊ represents the first answer probability mean of the first answer cluster, μ₋ represents the second answer probability mean of the second answer cluster, σ₊ represents the first cluster standard deviation corresponding to the first answer cluster, and σ₋ represents the second cluster standard deviation corresponding to the second answer cluster.

That is to say, by the algorithm as shown in the above formula, the ratio between the mean difference and the sum of squared values of the first cluster standard deviation and squared values of the second cluster standard deviation is obtained, and determined as the target distribution description data of the target answer results.

The method for training the question answering large language model proposed in this disclosure obtains the first answer cluster corresponding to the correct answer group and the second answer cluster corresponding to the wrong answer group in the target answer results, obtains the intra-cluster distribution data of the first answer cluster and the intra-cluster distribution data of the second answer cluster as well as the inter-cluster distribution data of the two answer clusters based on the first answer probabilities of respective first answers and the second answer probabilities of respective second answers, and then obtains the target distribution description data of the target answer results. This improves the accuracy and precision of obtaining the target distribution description data, thereby improving the accuracy and precision of the target distribution description data in describing the distribution of the target answer results. In the scenario of optimizing the candidate question answering large language model based on the update gradient corresponding to the target distribution description data, the optimization accuracy and effectiveness of the candidate question answering large language model is improved, and the robustness and performance of the target question answering large language model is enhanced.

In the above embodiments, regarding the training of the candidate question answering large language model, it can be further understood in conjunction with FIG. 3. FIG. 3 is a schematic flowchart of a method for training a question answering large language model according to another embodiment of the present disclosure. As shown in FIG. 3, the method includes the following content.

At S301, the output answers of a current answer round are sampled, to obtain current sampled answers of the current answer round to the sample question.

In embodiments of the disclosure, the candidate question answering large language model may generate answers to the same sample question for at least one round, and the round in which the current candidate question answering large language model generates answers to the input sample question may be determined as the current answer round.

In this scenario, the output answers of the candidate question answering large language model in the current answer round can be sampled based on a preset sampling method, wherein the output answers can be sampled and filtered based on the preset filtering and sampling condition to obtain at least some answers that meet the preset filtering and sampling condition from the output answers as the current sampled answers in the current sampling round.

It should be noted that the filtering and sampling condition may be set based on relevant conditions that can provide independent answers to the sample question, or based on other conditions, which are not specifically limited here.

At S302, historical sampled answers to the sample question are obtained, and sampled output answers to the sample question are obtained based on the current sampled answers and the historical sampled answers.

In embodiments of the disclosure, the candidate question answering large language model may have other answer rounds before the current answer round, wherein, other answers rounds that are earlier than the current answer round may be determined as historical answer rounds. In this scenario, the historical output answers under the historical answer rounds can be sampled to obtain answers that meet the preset condition. These answers can be determined as historical sampled answers under the historical answer rounds.

In embodiments of the disclosure, the current sampled answers in the current answer round and the historical sampled answers in the historical answer rounds may be integrated based on integration methods in related technologies, to obtain the answers meeting the requirement of being sampled in all the answer rounds that have occurred currently, and these answers can be determined as the sampled output answers to the sample question.

At S303, the target answer results to the sample question are obtained based on the sampled output answers.

Optionally, in response to a number of the sampled output answers being greater than or equal to a preset number, the sampled output answers are determined as the target answer results.

In embodiments of the disclosure, a quantity condition is set in the condition for sampling the output answers, which can be understood as: starting from the first answer round, the output answers of the candidate question answering large language model are sampled to obtain all sampled output answers that meet the condition from the first answer round to the current answer round, and the number of independent answers included in the sampled output answers is compared with the preset quantity condition, and then whether to end the sampling of the output answers is determined based on the comparison result.

That is to say, for the current answer round, if the number of independent answers included in the sampled output answers corresponding to the current answer round is greater than or equal to the number in the quantity condition, it can be determined that the sampled output answers can meet the training and optimization requirements of the candidate question answering large language model in the current round. In this scenario, the sampling operation of the output answers can be stopped, and the target answer results of the sample question obtained through the model capability of the candidate question answering large language model can be obtained based on the sampled output answers.

Optionally, in response to the number of sampled output answers being less than the preset number, the target answer results are obtained by: returning to a next answer round of obtaining the output answers to the sample question by the candidate question answering large language model, obtaining next sampled answers of the next answer round to the sample question, and obtaining next sampled output answers of the next answer round to the sample question, until a number of the next sampled output answers matches the predetermined number.

In embodiments of the disclosure, for the current answer round, if the number of independent answers included in the corresponding sampled output answers is less than the number in the quantity condition, it can be determined that the independent answers included in the sampled output answers cannot meet the training and optimization requirements of the candidate question answering large language model in the current round. That is to say, the output answers need to be sampled until a predetermined number of sampled output answers are obtained.

In this scenario, the sample question may be input into the candidate question answering large language model again to start the answer generation of the next answer round for the sample question by the candidate question answering large language model. Then, the output answers of the candidate question answering large language model in the next answer round may be further sampled to obtain the next sampled answers corresponding to the next answer round.

In this scenario, the number of independent answers included in the next sampled output answers may be further compared with the number in the quantity condition until the number of answers is greater than or equal to the set number carried in the quantity condition. This will stop the candidate question answering large language model from answering to the sample question and stop sampling the output answers corresponding to the sample question. Based on the sampled output answers that meet the conditions, the target answer results for the sample question can be obtained.

At S304, target distribution description data of the target answer results is obtained.

In embodiments of the disclosure, obtaining the target distribution description data can be understood in conjunction with the relevant content in the above embodiments, and will not be repeated here.

At S305, an adaptive weight of the candidate question answering large language model is obtained based on the target distribution description data.

Optionally, based on the target distribution description data and a preset weight sensitivity index, the adaptive weight of the candidate question answering large language model can be obtained.

As an example, the algorithm shown in the following formula can be used to process the target distribution description data and the preset weight sensitivity index to obtain the adaptive weight required for the candidate question answering large language model in the current round of training and optimization:

w_{q}=exp(−β×D′)
where, w_{q} represents the adaptive weight for the candidate question answering large language model, q represents the sample question input into the candidate question answering large language model in the current round, β represents the preset weight sensitivity index, and D′ represents the target distribution description data of the target answer results to the sample question.

It should be noted that the target distribution description data D′ shown in the above formula may be the modified and adjusted data obtained from the target distribution description data D in the above embodiments, which may be understood in conjunction with the following content.

Optionally, in response to the first answer probability mean of the first answer cluster in the target answer results being less than the second answer probability mean of the second answer cluster, the negative value of the absolute value of the target distribution description data is obtained to modify the target distribution description data to obtain the modified target distribution description data, and the adaptive weight is obtained based on the modified target distribution description data.

In embodiments of the disclosure, when the first answer probability mean of the first answer cluster is less than the second answer probability mean of the second answer cluster, it can be determined that the probability of the candidate question answering large language model outputting a correct answer in the current training round is lower than the probability of outputting a wrong answer. In this scenario, the target distribution description data corresponding to the target answer results in the current training round can be adjusted based on the adjustment method in related technologies, so that the optimized large language model based on the update gradient corresponding to the adjusted target distribution description data can improve the probability of outputting a correct answer.

In the scenario where the first answer probability mean is less than the second answer probability mean, the absolute value of the target distribution description data in that scenario can be obtained to obtain the negative value of the absolute value. Based on this operation, the target distribution description data can be modified, and the negative value can be determined as the modified target distribution description data. Based on the modified target distribution description data, the adaptive weight of the candidate question answering large language model can be calculated.

As an example, modifying the target distribution description data may be understood in conjunction with the following content:
if μ₊≥μ₋, then D′=D;
if μ₊<μ₋, then D′=−|D|.

In the above content, D represents the target distribution description data, D′ represents the target distribution description data for calculating the adaptive weight, μ₊ represents the first answer probability mean, μ₋ represents the second answer probability mean.

At S306, an update gradient of the candidate question answering large language model is obtained based on the adaptive weight, model parameters of the candidate question answering large language model are adjusted and optimized based on the update gradient to obtain the target question answering large language model.

In embodiments of the disclosure, the adaptive weight can be processed based on the update gradient obtaining algorithm in related technologies, and the update gradient required for optimizing the candidate question answering large language model in the current training round can be obtained based on the result of the processing by the algorithm.

Optionally, the standard advantage parameter of the candidate question answering large language model in the current training round is obtained, and weighted adjustment is performed on the standard advantage parameter based on the adaptive weight to obtain the update gradient of the candidate question answering large language model in the current training round.

In embodiments of the disclosure, the model performance quantification index of the candidate question answering large language model in the current training round can be obtained, and the standard advantage parameter of the candidate question answering large language model in the current training round can be obtained based on the model performance quantification index through the method for obtaining the model standard advantage parameter in related technologies.

In this scenario, the weighted adjustment algorithm in related technologies can be used to process the standard advantage parameter and adaptive weight of the candidate question answering large language model in the current training round, in order to weight the standard advantage parameter through the adaptive weight and obtain the update gradient required for model optimization of the candidate question answering large language model in the current training round.

As an example, the update gradient of the candidate question answering large language model in the current training round may be obtained based on the following formula:

Ã=Â×w_{q},θ←θ+α∇E[Ã×log π(y|q)]
where, ∇E[Ã×log π(y|q)] represents the update gradient in the current training round, Ã represents the weighted adjusted standard advantage parameter, Â represents the standard advantage parameter in the current training round, w_{q} represents the adaptive weight corresponding to the current training round, π represents the answer strategy of the candidate question answering large language model, used to characterize the probability of the candidate question answering large language model outputting an answer y based on question q, θ represents the parameter of π, α represents the learning rate, and E represents the expectation.

In embodiments of the disclosure, the model optimization method in related technologies can be used to adjust and optimize the model parameters of the candidate question answering large language model based on the update gradient in the current training round, and identify whether the optimized candidate question answering large language model meets the preset model training end condition. When the optimized candidate question answering large language model meets the model training end condition, the training of the candidate question answering large language model can be ended, and the optimized large language model can be determined as the target question answering large language model.

Correspondingly, if it is identified that the optimized candidate question answering large language model does not meet the model training end condition, the next sample question may be obtained to continue training the candidate question answering large language model until the training is completed, and the target question answering large language model is obtained.

The method for training the question answering large language model proposed in this disclosure obtains the update gradient required for optimizing the large language model based on the target answer results obtained by sampling the output answers, reducing the dependence of the question answering large language model on external data for model training, thereby reducing the training cost of the question answering large language model. The target distribution description data is judged and corrected, and the update gradient obtained based on corresponding adaptive weight is used to optimize the candidate question answering large language model, improving the optimization accuracy and effectiveness of the candidate question answering large language model. In the scenario where the probability of correct answer generation of the candidate question answering large language model is lower than that of wrong answer generation, the timeliness of adjusting the question answering large language model is improved, and the model performance of the target question answering large language model is optimized, improving the accuracy and precision of the target question answering large language model when answering questions. The model optimization is performed through the update gradient corresponding to the target distribution description data, enhancing the guidance of the target distribution description data for the model optimization of the candidate question answering large language model, improving the intuitiveness and quantifiability of the model optimization reference data, and optimizing the training method and training effect of the question answering large language model. In the scenario of answering questions based on the target question answering large language model, the efficiency and accuracy of answering questions is enhanced, and the user experience is improved.

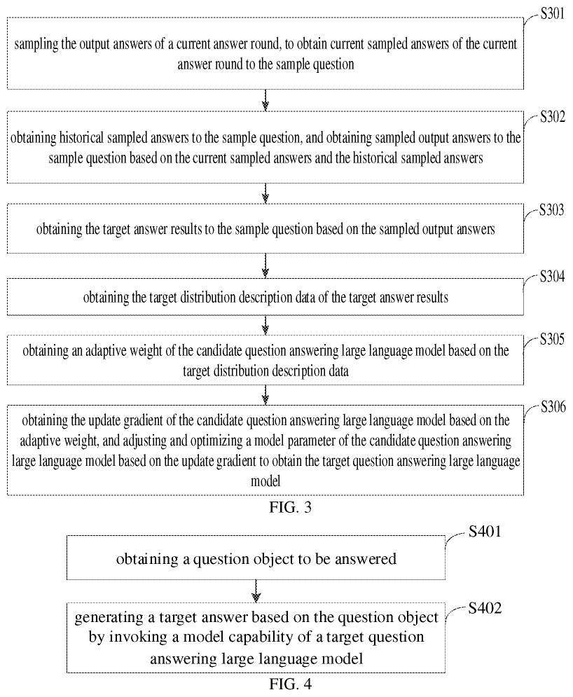

The disclosure also provides a method for answering questions, which may be understood in conjunction with FIG. 4. FIG. 4 is a schematic flowchart of a method for answering questions according to an embodiment of the present disclosure. As shown in FIG. 4, the method includes the following content.

At S401, a question object to be answered is obtained.

In embodiments of the disclosure, the question that needs to be answered can be identified as the question object to be answered. The question object can be obtained based on the query text received by the user terminal, the query audio received by the user terminal, or the query image received by the user terminal, which is not specifically limited here.

At S402, a target answer is generated based on the question object by invoking a model capability of a target question answering large language model.

The target question answering large language model is obtained based on the method for training a question answering large language model proposed in the embodiments of FIGS. 1 to 3 above.

In embodiments of the disclosure, the question object can be input into the target question answering large language model, and the model capability of the target question answering large language model can be used to parse and generate answers to the question object. The output answers can be determined as the target answers to the question object to answer the inquiry information received by the user terminal.

The method for answering questions proposed in this disclosure utilizes the model capability of the target question answering large language model to generate the target answer to the question object, improving the accuracy and precision of the target answer, as well as enhancing the efficiency of target answer generation, and optimizing the user experience on the user terminal.

Embodiments of the present disclosure also propose an apparatus for training a question answering large language model. Since the apparatus for training a question answering large language model proposed in the present disclosure corresponds to the method for training a question answering large language model proposed in the above embodiments, the implementation of the method for training a question answering large language model proposed in the present disclosure is also applicable to the apparatus for training a question answering large language model proposed in the present disclosure, and will not be described in detail in the following embodiments.

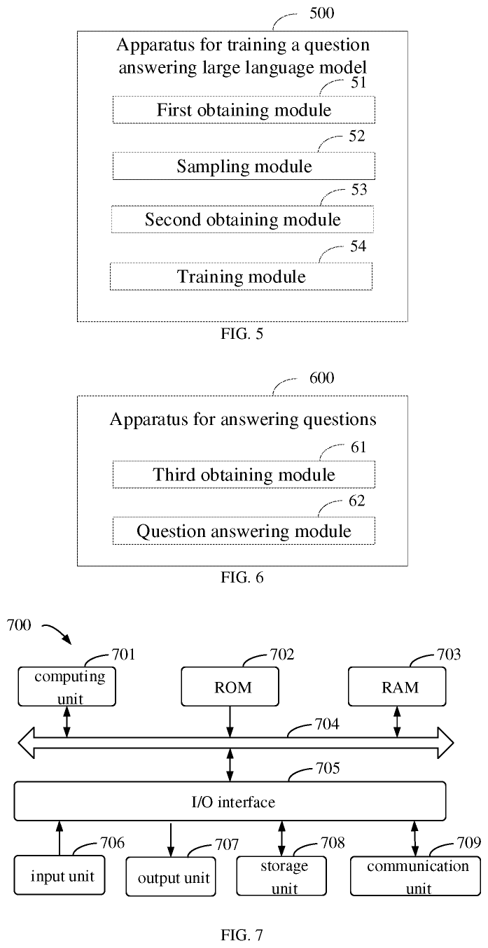

FIG. 5 is a block diagram of an apparatus for training a question answering large language model according to an embodiment of the present disclosure. As shown in FIG. 5, the apparatus 500 for training a question answering large language model includes a first obtaining module 51, a sampling module 52, a second obtaining module 53 and a training module 54.

The first obtaining module 51 is configured to obtain a candidate question answering large language model to be trained, and a corresponding sample question.

The sampling module 52 is configured to obtain output answers to the sample question by invoking a model capability of the candidate question answering large language model, and obtain target answer results to the sample question by sampling the output answers.

The second obtaining module 53 is configured to obtain a target distribution description data of the target answer results.

The training module 54 is configured to obtain an update gradient of the candidate question answering large language model based on the target distribution description data, and train the candidate question answering large language model based on the update gradient to obtain a target question answering large language model.

In embodiments of the disclosure, the second obtaining module 53 is further configured to: classify and cluster the target answer results to obtain a first answer cluster and a second answer cluster, wherein the first answer cluster is obtained based on clustering correct answers in the target answer results, and the second answer cluster is obtained based on clustering wrong answers in the target answer results; obtain respective intra-cluster distribution data of the first answer cluster and the second answer cluster, and inter-cluster distribution data between the first answer cluster and the second answer cluster; and obtain the target distribution description data of the target answer results based on the respective intra-cluster distribution data and the inter-cluster distribution data.

In embodiments of the disclosure, the second obtaining module 53 is further configured to: perform correctness verification on the target answer results to classify the target answer results to a group of correct answers that have passed the verification and a group of wrong answers that have not passed the verification; obtain a first answer probability of each first answer in the group of correct answers and a second answer probability of each second answer in the group of wrong answers; and cluster first answers based on first answer probabilities to obtain the first answer cluster, and clustering second answers based on second answer probabilities to obtain the second answer cluster.

In embodiments of the disclosure, the second obtaining module 53 is further configured to: for any third answer, obtain a token generation probability of each answer token in the third answer, and obtain a third answer probability of the third answer based on a probability mean of respective token generation probabilities; wherein the third answer is one of the first answers and the second answers, and the third answer probability is one of the first answer probability and the second answer probability.

In embodiments of the disclosure, the second obtaining module 53 is further configured to: for any third answer, obtain an intra-cluster distance between the third answer and a remaining answer in a third answer cluster to which the third answer belongs based on third answer probabilities of the third answer and the remaining answer, to obtain an intra-cluster mean distance corresponding to the third answer; and obtain intra-cluster distribution data of the third answer cluster based on the intra-cluster mean distances of respective third answers, wherein, the third answer cluster is one of the first answer cluster and the second answer cluster, the third answer probability is one of the first answer probability and the second answer probability, and the remaining answer is an answer other than the third answer in the third answer cluster.

In embodiments of the disclosure, the second obtaining module 53 is further configured to: for any of the first answers, obtain first inter-cluster distances between the first answer and respective second answers in the second answer cluster based on the first answer probability of the first answer and the second answer probabilities of respective second answers, to obtain a first inter-cluster mean distance corresponding to the first answer; for any of the second answers, obtain second inter-cluster distances between the second answer and respective first answers in the first answer cluster based on the second answer probability of the second answer and the first answer probabilities of respective first answers, to obtain a second inter-cluster mean distance corresponding to the second answer; and obtain the inter-cluster distribution data based on respective first inter-cluster mean distances of the first answers and respective second inter-cluster mean distances of the second answers.

In embodiments of the disclosure, the second obtaining module 53 is further configured to: obtain an answer evaluation parameter of each of the first answers and the second answers based on the respective intra-cluster distribution data and the inter-cluster distribution data; and obtain the target distribution description data based on a parameter mean value of answer evaluation parameters of respective first answers and second answers.

In embodiments of the disclosure, the second obtaining module 53 is further configured to: for any third answer, obtain a distance difference between the first inter-cluster mean distance corresponding to the third answer and the intra-cluster mean distance corresponding to the third answer based on the respective intra-cluster distribution data and the inter-cluster distribution data, and obtain the answer evaluation parameter of the third answer based on the distance difference, the first inter-cluster mean distance and the intra-cluster mean distance.

In embodiments of the disclosure, the second obtaining module 53 is further configured to: obtain a first answer probability mean of first answer probabilities of respective first answers in the first answer cluster, and obtain the intra-cluster distribution data of the first answer cluster based on the first answer probability mean; and obtain a second answer probability mean of second answer probabilities of respective second answers in the second answer cluster, and obtain the intra-cluster distribution data of the second answer cluster based on the second answer probability mean.

In embodiments of the disclosure, the second obtaining module 53 is further configured to: obtain a first cluster standard deviation corresponding to the first answer cluster based on respective first answer probabilities; obtain a second cluster standard deviation corresponding to the second answer cluster based on respective second answer probabilities; and obtain the inter-cluster distribution data between the first answer cluster and the second answer cluster based on the first cluster standard deviation and the second cluster standard deviation.

In embodiments of the disclosure, the second obtaining module 53 is further configured to: obtain a mean difference by subtracting the second answer probability mean from the first answer probability mean based on the respective intra-cluster distribution data, obtain a sum of respective squared values of the first cluster standard deviation and the second cluster standard deviation based on the inter-cluster distribution data, and obtain the target distribution description data of the target answer results based on the mean difference and the sum.

In embodiments of the disclosure, the sampling module 52 is further configured to: sample the output answers of a current answer round, to obtain current sampled answers of the current answer round to the sample question; obtain historical sampled answers to the sample question, and obtain sampled output answers to the sample question based on the current sampled answers and the historical sampled answers; and obtain the target answer results to the sample question based on the sampled output answers.

In embodiments of the disclosure, the sampling module 52 is further configured to: in response to a number of the sampled output answers being greater than or equal to a predetermined number, determine that the sampled output answers are the target answer results; and in response to the number of sampled output answers being less than the predetermined number, obtain the target answer results by: returning to a next answer round of obtaining the output answers to the sample question by the candidate question answering large language model, obtaining next sampled answers of the next answer round to the sample question, and obtaining next sampled output answers of the next answer round to the sample question, until a number of the next sampled output answers matches the predetermined number.

In embodiments of the disclosure, the training module 54 is further configured to: obtain an adaptive weight of the candidate question answering large language model based on the target distribution description data; and obtain the update gradient of the candidate question answering large language model based on the adaptive weight, and adjust and optimize a model parameter of the candidate question answering large language model based on the update gradient to obtain the target question answering large language model.

In embodiments of the disclosure, the training module 54 is further configured to: obtain the adaptive weight of the candidate question answering large language model based on the target distribution description data and a predetermined weight sensitivity index.

In embodiments of the disclosure, the training module 54 is further configured to: in response to a first answer probability mean of a first answer cluster being less than a second answer probability mean of a second answer cluster in the target answer results, obtain a negative value of an absolute value of the target distribution description data, modify the target distribution description data based on the negative value to obtain modified target distribution description data, and obtain the adaptive weight based on the modified target distribution description data.

In embodiments of the disclosure, the training module 54 is further configured to: obtain a standard advantage parameter of the candidate question answering large language model in a current training round, and perform weighted adjustment on the standard advantage parameter based on the adaptive weight to obtain the update gradient of the candidate question answering large language model in the current training round.

The apparatus for training a question answering large language model proposed in this disclosure utilizes the model capability of the candidate question answering large language model to generate output answers to the sample question, samples the output answers to obtain corresponding target answer results, and then obtains the update gradient of the candidate question answering large language model based on the target distribution description data corresponding to the target answer results, in order to train the candidate question answering large language model and obtain the target question answering large language model. In this disclosure, the update gradient required for optimizing the large language model is obtained based on the target answer results obtained through output answer sampling, which reduces the dependence of the model training of the question answering large language model on external data and thus reduces the training cost of the question answering large language model; the target distribution description data of the target answer results is used to optimize the candidate question answering large language model, which improves the model performance of the target question answering large language model, and optimizes the answer accuracy and precision of the target question answering large language model when answering questions; the model optimization is performed through the update gradient corresponding to the target distribution description data, which improves the guidance of the target distribution description data on the model optimization of the candidate question answering large language model, and improves the intuitiveness and quantifiability of the model optimization reference data. This optimizes the training method and training performance of the question answering large language model. In the scenario of question answering based on the target question answering large language model, the efficiency and accuracy of question answering have been improved, and the user experience has been optimized.

Embodiments of the present disclosure also propose an apparatus for answering questions. Since the apparatus for answering questions proposed in the present disclosure corresponds to the method for answering questions proposed in the above embodiments, the implementation of the method for answering questions proposed in the present disclosure is also applicable to the apparatus for answering questions proposed in the present disclosure, and will not be described in detail in the following embodiments.

FIG. 6 is a block diagram of an apparatus for answering questions according to an embodiment of the present disclosure. As shown in FIG. 6, the apparatus 600 for answering questions includes a third obtaining module 61 and a question answering module 62.

The third obtaining module 61 is configured to obtain a question object to be answered.

The question answering model 62 is configured to generate a target answer based on the question object by invoking a model capability of a target question answering large language model, wherein the target question answering large language model is obtained based on the apparatus 500 for training a question answering large language model proposed in the embodiment of FIG. 5.

The apparatus for answering questions proposed in this disclosure utilizes the model capability of the target question answering large language model to generate the target answer to the question object, improving the accuracy and precision of the target answer, as well as enhancing the efficiency of target answer generation, and optimizing the user experience on the user terminal.

According to embodiments of the present disclosure, the present disclosure also provides an electronic device, a readable storage medium and a computer program product.

FIG. 7 is a block diagram illustrating an electronic device 700 according to an embodiment of the disclosure. The electronic device is intended to represent various types of digital computers, such as laptop computers, desktop computers, workstations, personal digital assistants, servers, blade servers, mainframe computers, and other suitable computers. The electronic device may also represent various types of mobile devices, such as personal digital assistants, cellular phones, smart phones, wearable devices, and other similar computing devices. The components shown herein, their connections and relations, and their functions are merely examples, which are not intended to limit the implementations of the disclosure described and/or required here.

As shown in FIG. 7, the device 700 includes a computing unit 701, configured to execute various appropriate actions and processes according to a computer program stored in a read-only memory (ROM) 702 or a computer program loaded from a storage unit 708 to a random access memory (RAM) 703. In the RAM 703, various programs and data required for the device 700 may be stored. The computing unit 701, the ROM 702 and the RAM 703 may be connected with each other by a bus 704. An input/output (I/O) interface 705 is also connected to the bus 704.

The plurality of components in the device 700 are connected to the I/O interface 705, which include: an input unit 706, for example, a keyboard, a mouse; an output unit 707, for example, various types of displays, speakers; a storage unit 708, for example, a magnetic disk, an optical disk; and a communication unit 709, for example, a network card, a modem, a wireless transceiver. The communication unit 709 allows the device 700 to exchange information/data through a computer network such as Internet and/or various types of telecommunication networks with other devices.

The computing unit 701 may be various types of general and/or dedicated processing components with processing and computing abilities. Some examples of a computing unit 701 include but not limited to a central processing unit (CPU), a graphics processing unit (GPU), various dedicated artificial intelligence (AI) computing chips, various computing units on which a machine learning model algorithm is running, a digital signal processor (DSP), and any appropriate processor, controller, microcontroller, etc. The computing unit 701 executes various methods and processes as described above, for example, a method for generating training data. For example, in some embodiments, the method for generating training data may be further implemented as a computer software program, which is tangibly contained in a machine readable medium, such as the storage unit 708. In some embodiments, a part or all of the computer program may be loaded and/or installed on the device 700 via the ROM 702 and/or the communication unit 709. When the computer program is loaded on the RAM 703 and executed by the computing unit 701, one or more steps in the method for generating training data may be performed as described above. Optionally, in other embodiments, the computing unit 701 may be configured to the method for generating training data in other appropriate ways (for example, by virtue of a firmware).

Various implementations of the systems and techniques described above may be implemented by a digital electronic circuit system, an integrated circuit system, field programmable gate arrays (FPGAs), application specific integrated circuits (ASICs), application specific standard products (ASSPs), system on chip (SOCs), load programmable logic devices (CPLDs), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided for the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in combination with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the above. More specific examples of machine-readable storage media include electrical connections based on one or more wires, portable computer disks, hard disks, RAMS, ROMs, electrically programmable read-only-memory (EPROM), fiber optics, compact disc read-only memories (CD-ROM), optical storage devices, magnetic storage devices, or any suitable combination of the above.

In order to provide interaction with a user, the systems and techniques described herein may be implemented on a computer having a display device (e.g., a cathode ray tube (CRT) or a liquid crystal display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: a local area network (LAN), a wide area network (WAN), the Internet, and the block-chain network.

The computer system may include a client and a server. The client and server are generally remote from each other and interacting through a communication network. The client-server relation is generated by computer programs running on the respective computers and having a client-server relation with each other. The server may be a cloud server, also called a cloud computing server or cloud host, which is a host product in cloud computing service systems. The cloud server solves the defects of high management difficulty and weak business extensibility existing in traditional physical hosts and virtual private server services (VPS). The server may also be a server in a distributed system, or a server integrated with a block-chain.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of the disclosure shall be included in the protection scope of the disclosure.

What is claimed is:

1. A method for training a question answering large language model, comprising:
obtaining a candidate question answering large language model to be trained, and a corresponding sample question;
obtaining output answers to the sample question by invoking a model capability of the candidate question answering large language model, and obtaining target answer results to the sample question by sampling the output answers;
obtaining a target distribution description data of the target answer results; and
obtaining an update gradient of the candidate question answering large language model based on the target distribution description data, and training the candidate question answering large language model based on the update gradient to obtain a target question answering large language model.

2. The method of claim 1, wherein obtaining the target distribution description data of the target answer results comprises:
classifying and clustering the target answer results to obtain a first answer cluster and a second answer cluster, wherein the first answer cluster is obtained based on clustering correct answers in the target answer results, and the second answer cluster is obtained based on clustering wrong answers in the target answer results;
obtaining respective intra-cluster distribution data of the first answer cluster and the second answer cluster, and inter-cluster distribution data between the first answer cluster and the second answer cluster; and
obtaining the target distribution description data of the target answer results based on the respective intra-cluster distribution data and the inter-cluster distribution data.

3. The method of claim 2, wherein classifying and clustering the target answer results to obtain a first answer cluster and a second answer cluster, wherein the first answer cluster is obtained based on clustering correct answers in the target answer results, and the second answer cluster is obtained based on clustering wrong answers in the target answer results, comprises:
performing correctness verification on the target answer results to classify the target answer results to a group of correct answers that have passed the verification and a group of wrong answers that have not passed the verification;
obtaining a first answer probability of each first answer in the group of correct answers and a second answer probability of each second answer in the group of wrong answers; and
clustering first answers based on first answer probabilities to obtain the first answer cluster, and clustering second answers based on second answer probabilities to obtain the second answer cluster.

4. The method of claim 3, wherein obtaining a first answer probability of each first answer in the group of correct answers and a second answer probability of each second answer in the group of wrong answers comprises:
for any third answer, obtaining a token generation probability of each answer token in the third answer, and obtaining a third answer probability of the third answer based on a probability mean of respective token generation probabilities;
wherein the third answer is one of the first answers and the second answers, and the third answer probability is one of the first answer probability and the second answer probability.

5. The method of claim 2, wherein obtaining the respective intra-cluster distribution data of the first answer cluster and the second answer cluster comprises:
for any third answer, obtaining an intra-cluster distance between the third answer and a remaining answer in a third answer cluster to which the third answer belongs based on third answer probabilities of the third answer and the remaining answer, to obtain an intra-cluster mean distance corresponding to the third answer; and
obtaining intra-cluster distribution data of the third answer cluster based on the intra-cluster mean distances of respective third answers,
wherein, the third answer cluster is one of the first answer cluster and the second answer cluster, the third answer probability is one of the first answer probability and the second answer probability, and the remaining answer is an answer other than the third answer in the third answer cluster.

6. The method of claim 5, wherein obtaining the inter-cluster distribution data between the first answer cluster and the second answer cluster comprises:
for any of the first answers, obtaining first inter-cluster distances between the first answer and respective second answers in the second answer cluster based on the first answer probability of the first answer and the second answer probabilities of respective second answers, to obtain a first inter-cluster mean distance corresponding to the first answer;
for any of the second answers, obtaining second inter-cluster distances between the second answer and respective first answers in the first answer cluster based on the second answer probability of the second answer and the first answer probabilities of respective first answers, to obtain a second inter-cluster mean distance corresponding to the second answer; and
obtaining the inter-cluster distribution data based on respective first inter-cluster mean distances of the first answers and respective second inter-cluster mean distances of the second answers.

7. The method of claim 6, wherein obtaining the target distribution description data of the target answer results based on the respective intra-cluster distribution data and the inter-cluster distribution data comprises:
obtaining an answer evaluation parameter of each of the first answers and the second answers based on the respective intra-cluster distribution data and the inter-cluster distribution data; and
obtaining the target distribution description data based on a parameter mean value of answer evaluation parameters of respective first answers and second answers.

8. The method of claim 7, wherein obtaining an answer evaluation parameter of each of the first answers and the second answers based on the respective intra-cluster distribution data and the inter-cluster distribution data comprises:
for any third answer, obtaining a distance difference between the first inter-cluster mean distance corresponding to the third answer and the intra-cluster mean distance corresponding to the third answer based on the respective intra-cluster distribution data and the inter-cluster distribution data, and obtaining the answer evaluation parameter of the third answer based on the distance difference, the first inter-cluster mean distance and the intra-cluster mean distance.

9. The method of claim 3, wherein obtaining the respective intra-cluster distribution data of the first answer cluster and the second answer cluster comprises:
obtaining a first answer probability mean of first answer probabilities of respective first answers in the first answer cluster, and obtaining the intra-cluster distribution data of the first answer cluster based on the first answer probability mean; and
obtaining a second answer probability mean of second answer probabilities of respective second answers in the second answer cluster, and obtaining the intra-cluster distribution data of the second answer cluster based on the second answer probability mean.

10. The method of claim 9, wherein obtaining the inter-cluster distribution data between the first answer cluster and the second answer cluster comprises:
obtaining a first cluster standard deviation corresponding to the first answer cluster based on respective first answer probabilities;
obtaining a second cluster standard deviation corresponding to the second answer cluster based on respective second answer probabilities; and
obtaining the inter-cluster distribution data between the first answer cluster and the second answer cluster based on the first cluster standard deviation and the second cluster standard deviation.

11. The method of claim 10, wherein obtaining the target distribution description data of the target answer results based on the respective intra-cluster distribution data and the inter-cluster distribution data comprises:
obtaining a mean difference by subtracting the second answer probability mean from the first answer probability mean based on the respective intra-cluster distribution data, obtaining a sum of respective squared values of the first cluster standard deviation and the second cluster standard deviation based on the inter-cluster distribution data, and obtaining the target distribution description data of the target answer results based on the mean difference and the sum.

12. The method of claim 1, wherein obtaining the output answers to the sample question by invoking the model capability of the candidate question answering large language model, and obtaining the target answer results to the sample question by sampling the output answers comprise:
sampling the output answers of a current answer round, to obtain current sampled answers of the current answer round to the sample question;
obtaining historical sampled answers to the sample question, and obtaining sampled output answers to the sample question based on the current sampled answers and the historical sampled answers; and
obtaining the target answer results to the sample question based on the sampled output answers.

13. The method of claim 12, wherein obtaining the target answer results to the sample question based on the sampled output answers comprises:
in response to a number of the sampled output answers being greater than or equal to a predetermined number, determining that the sampled output answers are the target answer results; and
in response to the number of sampled output answers being less than the predetermined number, obtaining the target answer results by: returning to a next answer round of obtaining the output answers to the sample question by the candidate question answering large language model, obtaining next sampled answers of the next answer round to the sample question, and obtaining next sampled output answers of the next answer round to the sample question, until a number of the next sampled output answers matches the predetermined number.

14. The method of claim 1, wherein obtaining the update gradient of the candidate question answering large language model based on the target distribution description data, and training the candidate question answering large language model based on the update gradient to obtain the target question answering large language model comprise:
obtaining an adaptive weight of the candidate question answering large language model based on the target distribution description data; and
obtaining the update gradient of the candidate question answering large language model based on the adaptive weight, and adjusting and optimizing a model parameter of the candidate question answering large language model based on the update gradient to obtain the target question answering large language model.

15. The method of claim 14, wherein obtaining the adaptive weight of the candidate question answering large language model based on the target distribution description data comprises:
obtaining the adaptive weight of the candidate question answering large language model based on the target distribution description data and a predetermined weight sensitivity index.

16. The method of claim 15, further comprising:
in response to a first answer probability mean of a first answer cluster being less than a second answer probability mean of a second answer cluster in the target answer results, obtaining a negative value of an absolute value of the target distribution description data, modifying the target distribution description data based on the negative value to obtain modified target distribution description data, and obtaining the adaptive weight based on the modified target distribution description data.

17. The method of claim 14, wherein obtaining the update gradient of the candidate question answering large language model based on the adaptive weight comprises:
obtaining a standard advantage parameter of the candidate question answering large language model in a current training round, and performing weighted adjustment on the standard advantage parameter based on the adaptive weight to obtain the update gradient of the candidate question answering large language model in the current training round.

18. A method for answering questions, comprising:
obtaining a question object to be answered; and
generating a target answer based on the question object by invoking a model capability of a target question answering large language model, wherein the target question answering large language model is obtained based on the method for training a question answering large language model of claim 1.

19. An electronic device, comprising:
at least one processor; and
a memory communicatively coupled to the at least one processor,
wherein the memory stores instructions executable by the at least one processor, and when the instructions are executed by the at least one processor, the at least one processor is caused to:
obtain a candidate question answering large language model to be trained, and a corresponding sample question;
obtain output answers to the sample question by invoking a model capability of the candidate question answering large language model, and obtain target answer results to the sample question by sampling the output answers;
obtain a target distribution description data of the target answer results; and
obtain an update gradient of the candidate question answering large language model based on the target distribution description data, and train the candidate question answering large language model based on the update gradient to obtain a target question answering large language model.

20. An electronic device, comprising:
at least one processor; and
a memory communicatively coupled to the at least one processor,
wherein the memory stores instructions executable by the at least one processor, and when the instructions are executed by the at least one processor, the at least one processor is caused to perform the method of claim 18.
